(19) United States
(12) Patent Application Publication
(10) Pub. No.: US 2026/0154505 A1
(43) Pub. Date: Jun. 4, 2026

(54) INFORMATION PROCESSING APPARATUS, INFORMATION PROCESSING METHOD, AND NON-TRANSITORY COMPUTER READABLE MEDIUM

(71) Applicant: NEC Corporation, Tokyo (JP)

(72) Inventors: Tasuku KITADE, Tokyo (JP); Masanori Tsujikawa, Tokyo (JP)

(73) Assignee: NEC Corporation, Tokyo (JP)

(21) Appl. No.: 19/399,717

(22) Filed: Nov. 25, 2025

(30) Foreign Application Priority Data
Nov. 29, 2024 (JP) 2024-208603

(51) Int. Cl. G06F 40/289; G06F 40/166

(52) U.S. Cl. CPC G06F 40/289; G06F 40/166

(57) ABSTRACT

An information processing apparatus includes a text acquisition unit which acquires voice recognition text, a topic acquisition unit which acquires a topic included between boundaries by estimating the boundaries of a topic in the voice recognition text using a topic boundary estimation model for estimating boundaries of a topic in the text, a summary generation unit which generates a summary of the topic and an important phrase for each range of the voice recognition text divided by the boundaries, and a display processing unit which displays at least two display regions among at least three display regions respectively displaying the voice recognition text, the summary, and the important phrase in parallel on a display screen while the at least two display regions are each divided into ranges different in the topic. The information processing apparatus, for example, may assist decision-making based on the result of voice recognition.

### INCORPORATION BY REFERENCE

This application is based upon and claims the benefit of priority from Japanese patent application No. 2024-208603, filed on Nov. 29, 2024, the disclosure of which is incorporated herein in its entirety by reference.

### TECHNICAL FIELD

The present disclosure relates to an information processing apparatus, an information processing method, and an information processing program.

### BACKGROUND ART

There is known a technique of converting speech contents into a text from data in which a speech voice is recorded. Examples of this technique include a voice recognition result display apparatus described in WO 2024/095535 A1. This apparatus includes a display unit with a screen including a display region of speech contents, the display region displaying a voice recognition result text of a voice recognition result of a latest speech and a summary text obtained by summarizing the voice recognition result text of a speech previous to the latest speech.

### SUMMARY

The voice recognition result display device described in WO 2024/095535 A1 displays a voice recognition result text and a summary text obtained by summarizing a voice recognition result text of a speech previous to the voice recognition result text. Unfortunately, a part of the voice recognition result text, which corresponds to the summary text, is less likely to be found. In particular, correspondence between the two texts is less likely to be understood for conversation increased in number of topics or conversation for a long time.

The present disclosure has been made in view of the above aspects, and an exemplary object thereof is to provide a technique for suitably displaying information regarding a voice recognition result even for conversation with many topics and for a long time.

An information processing apparatus according to an exemplary aspect of the present disclosure includes: a text acquisition unit configured to acquire voice recognition text obtained by converting voice into text; a topic acquisition unit configured to acquire a topic included between boundaries by estimating the boundaries of a topic in the voice recognition text using a topic boundary estimation model for estimating boundaries of a topic in the text; a summary generation unit configured to generate a summary of the topic and an important phrase for each range of the voice recognition text divided by the boundaries; and a display processing unit configured to display at least two display regions among at least three display regions respectively displaying the voice recognition text, the summary, and the important phrase in parallel on a display screen while the at least two display regions are each divided into ranges different in the topic.

An information processing method according to an exemplary aspect of the present disclosure includes: acquiring voice recognition text obtained by converting voice into text; acquiring a topic included between boundaries by estimating the boundaries of a topic in the voice recognition text using a topic boundary estimation model for estimating boundaries of a topic in the text; generating a summary of the topic and an important phrase for each range of the voice recognition text divided by the boundaries; and displaying at least two display regions among at least three display regions respectively displaying the voice recognition text, the summary, and the important phrase in parallel on a display screen while the at least two display regions are each divided into ranges different in the topic.

An information processing program according to an exemplary aspect of the present disclosure causes a computer to perform: text acquisition processing of acquiring voice recognition text obtained by converting voice into text; topic acquisition processing of acquiring a topic included between boundaries by estimating the boundaries of a topic in the voice recognition text using a topic boundary estimation model for estimating boundaries of a topic in the text; generation processing of generating a summary of the topic and an important phrase for each range of the voice recognition text divided by the boundaries; and display processing of displaying at least two display regions among at least three display regions respectively displaying the voice recognition text, the summary, and the important phrase in parallel on a display screen while the at least two display regions are each divided into ranges different in the topic.

Each of the exemplary aspects of the present disclosure achieves an exemplary effect in which a technique for suitably displaying information regarding a voice recognition result can be provided even for conversation with many topics and for a long time.

### BRIEF DESCRIPTION OF DRAWINGS

FIG. 1 is a block diagram illustrating a configuration of an information processing apparatus 1 according to the present disclosure;

FIG. 2 is a flowchart illustrating a flow of an information processing method S1 according to the present disclosure;

FIG. 3 is a block diagram illustrating a configuration of an information processing apparatus 1A according to the present disclosure;

FIG. 4 is a schematic diagram illustrating an example of an image displayed on a display unit according to the present disclosure;

FIG. 5 is a schematic diagram illustrating an example of another image displayed on the display unit;

FIG. 6 is a schematic diagram illustrating an example of yet another image displayed on the display unit;

FIG. 7 is a schematic diagram illustrating an example of yet another image displayed on the display unit;

FIG. 8 is a block diagram illustrating a configuration of an information processing apparatus 1B according to the present disclosure; and

FIG. 9 is a block diagram illustrating a configuration of a computer that functions as the information processing apparatus according to the present disclosure.

### EXAMPLE EMBODIMENT

Hereinafter, example embodiments of the present disclosure will be exemplified. However, the present disclosure is not limited to the following exemplary example embodiments, and various modifications can be made within a scope described in the claims. For example, example embodiments obtained by appropriately combining techniques (some or all of things or methods) used in the following exemplary example embodiments can also be included in the scope of the present disclosure. Example embodiments obtained by appropriately omitting some of the techniques used in the following exemplary example embodiments can also be included in the scope of the present disclosure. Effects mentioned in the following exemplary example embodiments are examples of effects expected in the exemplary example embodiments, and do not define extension of the present disclosure. In other words, example embodiments that do not provide the effects mentioned in each of the following exemplary example embodiments can also be included in the scope of the present disclosure.

### First Exemplary Example Embodiment

A first exemplary example embodiment that is an example of the example embodiments of the present disclosure will be described in detail with reference to the drawings. The present exemplary example embodiment is a basic form of each exemplary example embodiment to be described below. An application range of each technique used in the present exemplary example embodiment is not limited to the present exemplary example embodiment. That is, each technique used in the present exemplary example embodiment can also be used in another exemplary example embodiment included in the present disclosure within a range in which no particular technical problem occurs. Each technique illustrated in the drawings referred to for describing the present exemplary example embodiment can also be used in another exemplary example embodiment included in the present disclosure within a range in which no particular technical problem occurs.

### (Configuration of Information Processing Apparatus 1)

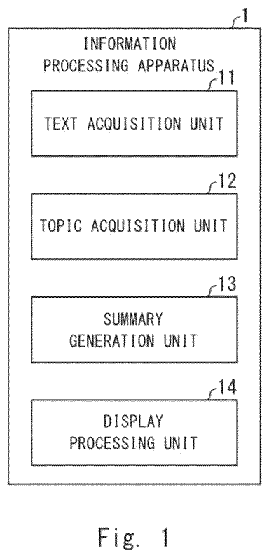

A configuration of an information processing apparatus 1 according to the present exemplary example embodiment will be described with reference to FIG. 1. FIG. 1 is a block diagram illustrating a configuration of the information processing apparatus 1. The information processing apparatus 1 displays data obtained by converting voice into text on one display screen by dividing the data into a text, a summary, and the like for each topic. The information processing apparatus 1 can analyze voice recognition text in a specialized technical field. For example, the information processing apparatus 1 may display a text including a technical phrase of a conversation between a patient and a doctor in a hospital or the like, a summary thereof, an important phrase, and the like. As illustrated in FIG. 1, the information processing apparatus 1 includes a text acquisition unit 11, a topic acquisition unit 12, a summary generation unit 13, and a display processing unit 14.

The text acquisition unit 11 acquires a voice recognition text obtained by converting voice into text. The voice recognition text can be generated from data in which voice is recorded using a known technique. The voice recognition text (also referred to below simply as “text”) may be recorded in any memory or database, and the text acquisition unit 11 may acquire the voice recognition text recorded in advance and record the voice recognition text in a memory of the information processing apparatus 1. Alternatively, the text acquisition unit 11 may acquire the voice recognition text that is generated from voice data using a program for generating the voice recognition text and recorded in the memory of the information processing apparatus 1.

The text acquisition unit 11 may also correct an error included in the acquired voice recognition text.

The topic acquisition unit 12 estimates boundaries of a topic in the voice recognition text using a topic boundary estimation model for estimating the boundaries of the topic in the text, and acquires a topic included between the boundaries. The topic boundary estimation model is any known machine model. The topic boundary estimation model calculates a degree of approximation of a topic (a theme, a domain) represented by a word included in the text, for example. Then, processing of dividing topic boundaries is performed to define one topic range in which words for approximate topics continue.

For example, the topic acquisition unit 12 inputs the voice recognition text acquired by the text acquisition unit 11 into the topic boundary estimation model provided in the information processing apparatus 1, and acquires a topic boundary output from the topic boundary estimation model.

Alternatively, the topic acquisition unit 12 may use a topic boundary estimation model provided outside the information processing apparatus 1. In that case, the topic acquisition unit 12 can input a voice recognition text into the topic boundary estimation model provided outside through the Internet and acquire a topic boundary (also referred to below simply as a “boundary”) output from the topic boundary estimation model through the Internet. The boundary may exist before or after one sentence, or before or after a plurality of sentences. Boundaries determined to exist before and after one sentence correspond to a case where only one sentence related to a certain topic exists.

The topic acquisition unit 12 acquires (extracts) a topic from one or more text sentences between two boundaries. The topic may be extracted from the text by any method. For example, the topic boundary estimation model outputs a common topic represented by a word frequently included in a certain range divided by boundaries as a topic in the range. The topic acquisition unit 12 may acquire the topic output from the topic boundary estimation model as a topic in the range. For only one sentence existing between two boundaries, the topic acquisition unit 12 may acquire a conversation target included in the sentence as a topic.

The topic acquisition unit 12 records the acquired topic in the memory of the information processing apparatus 1.

The summary generation unit 13 generates a summary of topics and an important phrase for each range of the voice recognition text divided by the boundaries. The summary generation unit 13 acquires text between the boundaries, the text being acquired by the topic acquisition unit 12, generates a summary from the text, and extracts important phrases from the text and edits the important phrases. The summary generation unit 13 may create the summary from the text or the important phrases (candidates) using a large language model. Important phrase candidates are presumed to be important to a conversational party of the text, particularly an expert (e.g., a doctor). The summary may be created by any technique. For example, the summary generation unit 13 may input the text into the large language model to create the summary. The summary generation unit 13 may generate a summary for a plurality of sentences or all of sentences (one topic) included between two topic boundaries, or may generate a summary for one sentence.

The summary generation unit 13 may also generate important phrase candidates. The summary generation unit 13 may generate important phrase candidates for each sentence. The summary generation unit 13 may generate important phrase candidates from the summary. The summary generation unit 13 can generate a phrase as an important phrase, the phrase being designated as an important phrase by the expert from among the important phrase candidates. This generation enables not only important phrases to be listed without omission, but also unnecessary phrases to be prevented from being set as the important phrases.

Alternatively, the summary generation unit 13 may generate a phrase estimated to be considered important by an expert (e.g., a doctor) as an important phrase instead of the important phrase candidates. The summary generation unit 13 records the generated summary, important phrase candidates, and/or important phrases in the memory of the information processing apparatus 1 together with the topic and the voice recognition text.

The summary generation unit 13 may extract an important phrase (candidate) by any method. For example, a user (expert or the like) may create a list of keywords of important phrases in advance for each specialized field, and the summary generation unit 13 may select a phrase including a keyword in the list. Alternatively, the summary generation unit 13 may extract an important phrase by using a machine model trained using learning data to which important phrases and labels thereof are attached.

The display processing unit 14 displays at least two display regions among at least three display regions that respectively display the voice recognition text, the summary, and the important phrases in parallel on the display screen while the at least two display regions are each divided into ranges different in the topic acquired by the topic acquisition unit 12.

The display regions are each a dedicated region for displaying corresponding one of three contents of the voice recognition text, the summary, and the important phrases, in which a name of the corresponding one of the three contents is added as a tag, for example. The number of display regions (contents) is not limited to three of the voice recognition text, the summary, and the important phrases. For example, a display region of important phrase candidates may be further provided. A display region may be provided in which relevant medical data (electronic medical records, inspection results, other related medical documents, and the like) is displayed. Although an example of displaying the above three display contents (the voice recognition text, the summary, the important phrases) will be described below, any combination of display contents may be displayed. By the user selecting at least two of these regions, the regions are displayed in parallel on a display screen of a display device (display). Displaying the regions in parallel means that the regions are disposed side by side horizontally or vertically. For a horizontally long display, horizontal placement side by side is preferable from the viewpoint of readability. The display regions are not required to be displayed in one screen or window. For example, each display region may be displayed as a pop-up window partially overlapping with another display region in response to operation of the user, or may be displayed in another window.

Displaying the display contents by dividing the display contents for each topic means that the display contents are displayed to enable each topic in the range of the voice recognition text divided by boundaries to be recognized. The display processing unit 14 generates display data as described above and outputs the display data to a display device outside or inside the information processing apparatus 1.

Once the user designates a certain topic, the display processing unit 14 may display a range including the topic in each display region. Alternatively, if the user scrolls in one display region to change a topic, the display processing unit 14 may follow the change and scroll display contents of other display regions to the changed topic.

The text acquisition unit 11, the topic acquisition unit 12, the summary generation unit 13, and the display processing unit 14 can be implemented by a processor that reads and executes a program describing functions of each unit, for example.

### (Effects of Information Processing Apparatus)

As described above, the information processing apparatus 1 uses a configuration including: a text acquisition unit configured to acquire voice recognition text obtained by converting voice into text; a topic acquisition unit configured to acquire a topic included between boundaries by estimating the boundaries of a topic in the voice recognition text using a topic boundary estimation model for estimating boundaries of a topic in the text; a summary generation unit configured to generate a summary of the topic and an important phrase for each range of the voice recognition text divided by the boundaries; and a display processing unit configured to display at least two display regions among at least three display regions respectively displaying the voice recognition text, the summary, and the important phrase in parallel on a display screen while display contents are displayed in association with corresponding topics in each of the at least two display regions. Thus, the information processing apparatus 1 enables obtaining an effect in which information regarding a voice recognition result can be suitably displayed by separating a range in which a different topic is described even for a conversation with many topics and a long conversation.

For example, a conversation between a doctor and a patient has been attempted to be mechanically converted into a text to efficiently support work of the doctor to create a document even in a medical field and the like. However, contents of a long conversation including various contents are less likely to be quickly grasped only by simply converting the conversation into text. Thus, using the technique as described above enables the doctor (expert) to quickly grasp contents of a conversation, so that documentation work of the expert can be efficiently supported.

### (Flow of Information Processing Method)

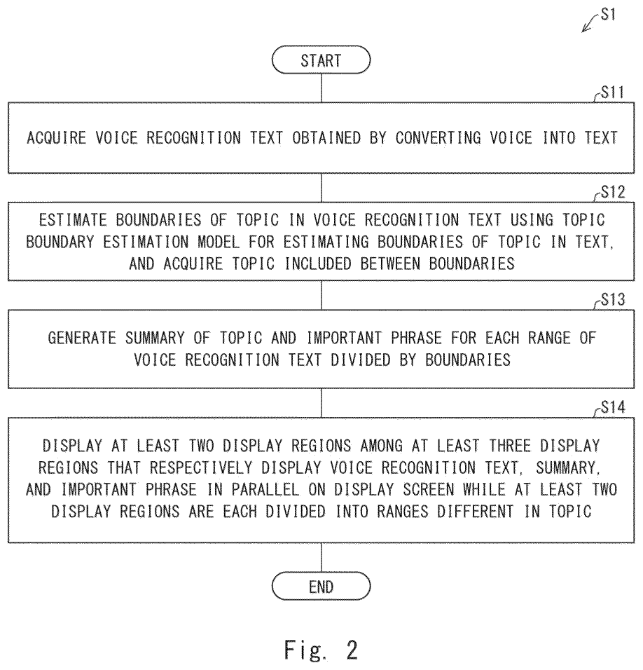

A flow of an information processing method S1 will be described with reference to FIG. 2. FIG. 2 is a flowchart illustrating the flow of the information processing method S1. As illustrated in FIG. 2, the information processing method S1 includes text acquisition processing S11, topic acquisition processing S12, generation processing S13, and display processing S14.

The text acquisition processing S11 is performed to acquire a voice recognition text obtained by converting voice into text. The text acquisition processing S11 is performed by the text acquisition unit 11 (one processor), for example. Contents of the text acquisition processing S11 are as described for the text acquisition unit 11.

The topic acquisition processing S12 is performed to estimate boundaries of a topic in the voice recognition text using a topic boundary estimation model for estimating the boundaries of the topic in the text, and acquire a topic included between the boundaries. The topic acquisition processing S12 is performed by the topic acquisition unit 12 (one processor), for example. Contents of the topic acquisition processing S12 are as described for the topic acquisition unit 12.

The generation processing S13 is performed to generate a summary of a topic and an important phrase for each range of the voice recognition text divided by boundaries. The generation processing S13 is performed by the summary generation unit 13 (one processor), for example. Contents of the generation processing S13 are as described for the summary generation unit 13.

The display processing S14 is performed to display at least two display regions among at least three display regions that respectively display the voice recognition text, the summary, and the important phrases in parallel on the display screen while the at least two display regions are each divided into ranges different in the topic. The display processing S14 is performed by the display processing unit 14 (one processor), for example. Contents of the display processing S14 are as described for the display processing unit 14.

### (Effect of Information Processing Method)

As described above, the information processing method S1 uses a configuration in which at least one processor performs: acquiring voice recognition text obtained by converting voice into text; acquiring a topic included between boundaries by estimating the boundaries of a topic in the voice recognition text using a topic boundary estimation model for estimating boundaries of a topic in the text; generating a summary of the topic and an important phrase for each range of the voice recognition text divided by the boundaries; and displaying at least two display regions among at least three display regions respectively displaying the voice recognition text, the summary, and the important phrase in parallel on a display screen while display contents are displayed in association with corresponding topics in each of the at least two display regions. Thus, the information processing method S1 enables obtaining an effect in which information regarding a voice recognition result can be suitably displayed by separating a range in which a different topic is described even for a conversation with many topics and a long conversation.

### Second Exemplary Example Embodiment

A second exemplary example embodiment that is an example of the example embodiments of the present disclosure will be described in detail with reference to the drawings. Components having the same functions as the components described in the above-described exemplary example embodiment will be denoted by the same reference signs, and description of the components will be appropriately omitted. An application range of each technique used in the present exemplary example embodiment is not limited to the present exemplary example embodiment. That is, each technique used in the present exemplary example embodiment can also be used in another exemplary example embodiment included in the present disclosure within a range in which no particular technical problem occurs. Each technique illustrated in each of the drawings referred to for describing the present exemplary example embodiment can be employed in the other exemplary example embodiments included in the present disclosure within the scope in which no particular technical problem occurs.

### (Configuration of Information Processing Apparatus 1A)

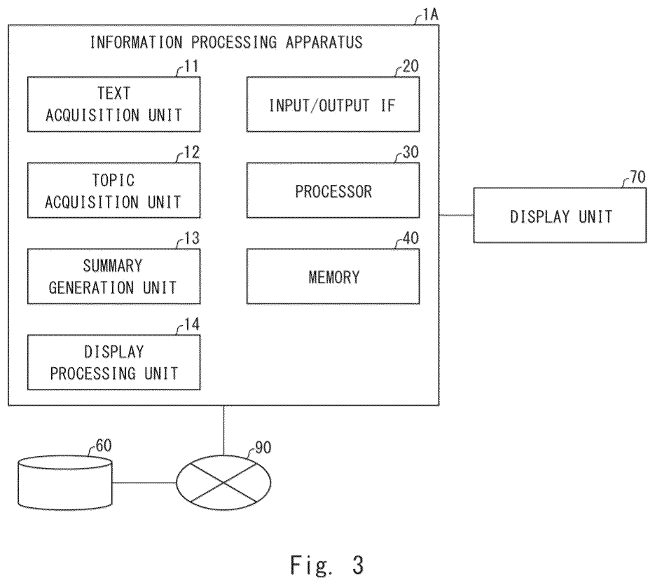

Next, a configuration of an information processing apparatus 1A will be described with reference to FIG. 3. FIG. 3 is a block diagram illustrating the configuration of the information processing apparatus 1A. The information processing apparatus 1A includes not only the text acquisition unit 11, the topic acquisition unit 12, the summary generation unit 13, and the display processing unit 14 provided in the information processing apparatus 1, but also an input/output interface (input/output IF) 20, at least one processor 30, and at least one memory 40. The information processing apparatus 1A may be also connected to a display unit (display) 70.

The processor 30 can be configured using a general-purpose processor such as at least one micro processing unit (MPU) or a central processing unit (CPU). The processor 30 may include a dedicated processor including an application specific integrated circuit (ASIC), a field programmable gate array (FPGA), or a programmable logic device (PLD).

The memory 40 may include a plurality of types of memories such as a read only memory (ROM) and a random access memory (RAM). The memory 40 may also include a built-in or external memory such as a hard disk drive (HDD) or a solid state drive (SSD). As an example, the processor 20 implements functions as the text acquisition unit 11, the topic acquisition unit 12, the summary generation unit 13, and the display processing unit 14 by developing various control programs recorded in the ROM of the memory 40 in the RAM and executing the programs. Additionally, data such as various programs, voice recognition text, summaries, and important phrases may be recorded in a database 60 or the like disposed outside.

The input/output IF 20 is configured to transmit and receive data to and from the outside. Communication between the input/output IF 20 and the outside (e.g., the database 60) may be performed through the Internet 90, for example. The input/output IF 20 may include a short-range communication device such as WiFi (registered trademark) or Bluetooth (registered trademark) that can wirelessly connect to a connection point of the Internet, for example. The input/output IF 20 may be a wired connection interface such as a USB connector.

The display processing unit 14 may display at least two of a voice recognition text, a summary, and important phrases in a display region by associating the at least two with each other, for example. The association with each other may be a display in which items identical in topic are displayed in different display regions in parallel in one screen, for example. For example, at least two display regions each displaying the same topic on one display screen enables the user to facilitate comparison and understanding of contents even with a long text. The same phrase in different display regions may be displayed by scrolling. Alternatively, the same highlighting (marking, highlight, etc.) may be applied, or these may be combined. A display method as described above enables the user to easily check what important phrase has come out in what topic, for example.

### (Specific Example of Display Image)

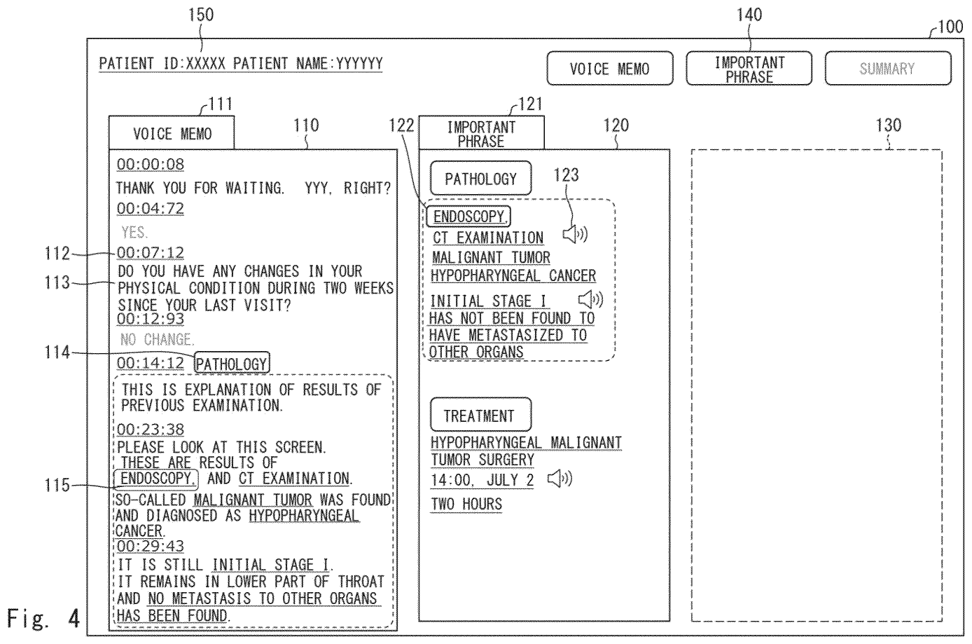

FIG. 4 is a schematic diagram illustrating an image 100 displayed in a display unit 70. The image 100 illustrates an example in which a display region 110 and a display region 120 are displayed by default. The display region 110 displays a voice recognition text (voice memo) together with a title 111 indicating a “voice memo”. The display region 120 displays an important phrase and a title 121 indicating an “important phrase”. The voice recognition text of the present exemplary example embodiment is acquired by converting conversation between a doctor and a patient in a hospital into text. FIG. 4 illustrates an example in which nothing is displayed in a region 130. FIG. 4 displays selection buttons 140 in its upper right part, and the user taps each selection button to switch between display and non-display. The illustrated example enables three items of “voice memo”, “important phrase”, and “summary” to be selected.

The buttons of the “voice memo” and the “important phrase” in which contents are displayed are highlighted, and the button of the “summary” in which no content is displayed is displayed lightly. FIG. 4 displays a patient ID 150 in its upper left part.

The display region 110 displays time 112 and contents 113 of a conversation at that time in time series, for example. The display processing unit 14 of the information processing apparatus 1A further displays an item name of a topic for each display region. For example, the display region 110 displays an item 114 of a topic of the conversation, the item 114 being highlighted by a frame enclosure or the like and disposed at a place where the topic starts. The example illustrated in FIG. 4 displays not only an item “pathology” of a topic, but also a range where the topic of the “pathology” continues, the range being defined by a dotted line. Divisions of the item of the topic and the range where the item of the topic is displayed may be displayed in any mode.

The display processing unit 14 may change the display mode for each of topics displayed. For example, the range of the item “pathology” may be marked in blue, and a range of an item “treatment” may be marked in yellow. Consequently, the user can easily recognize a range of one topic.

An item of a topic may be designated by the user in advance, for example. For one or more items related to a topic given by the user in advance, the topic acquisition unit 12 of the information processing apparatus 1A acquires the topic and assigns at least any one of the items to the acquired topic. For no item of a topic designated by the user, an item of a topic acquired by the topic acquisition unit 12 can be used. For example, the “pathology” of the item 114 displayed in the display regions 110 and 120, and the item “treatment” displayed in the display region 120 are designated by the user in advance.

A phrase determined to be an important phrase is displayed with an underline 115. As described in the exemplary example embodiment, an important phrase may be selected by the user (e.g., a doctor) from important phrase candidates or voice memos, or may be generated by the summary generation unit 13. The summary generation unit 13 may switch a method for extracting a summary or an important phrase, based on an utterer or a topic. In this case, the text acquisition unit 11 records voice recognition text so that the text can be distinguished for each utterer uttered a voice. For example, the summary generation unit 13 may extract a summary or an important phrase only from speech words of an expert.

For a technical term existing and corresponding to an important phrase, the summary generation unit 13 may replace the important phrase with the corresponding technical term. Plain terms may be used in a conversation between a doctor and a patient or in voice recognition text thereof. Thus, replacing such plain terms with technical terms allows the expert to read easily. For example, a technical term conversion rule or dictionary in which “cold is converted to common cold” may be prepared in advance, and the summary generation unit 13 may be configured to perform conversion in a case where a corresponding character string is found.

For a mouse operation (click or the like) performed on an important phrase or topic in one display region having been displayed, the display processing unit 14 may cause scrolling to a place of the important phrase or the topic in another display region having been displayed. For example, once a cursor is placed on an important phrase and clicked, the important phrase is scrolled to and displayed in another display region. FIG. 4 illustrates the example in which the user clicks “endoscopy” in the display region 110, and then the “endoscopy” is scrolled to the top and displayed in the display region 120, for example. The clicked phrase (endoscopy) is surrounded by a frame (highlighted).

“Important phrases” are collected and displayed in the display region 120. Clicking any one of the “important phrases” displayed in the display region 120 enables calling up the “important phrase” displayed in the display region 110. Once a voice mark 122 is clicked, the user is allowed to listen to voice data on a matter in this display region.

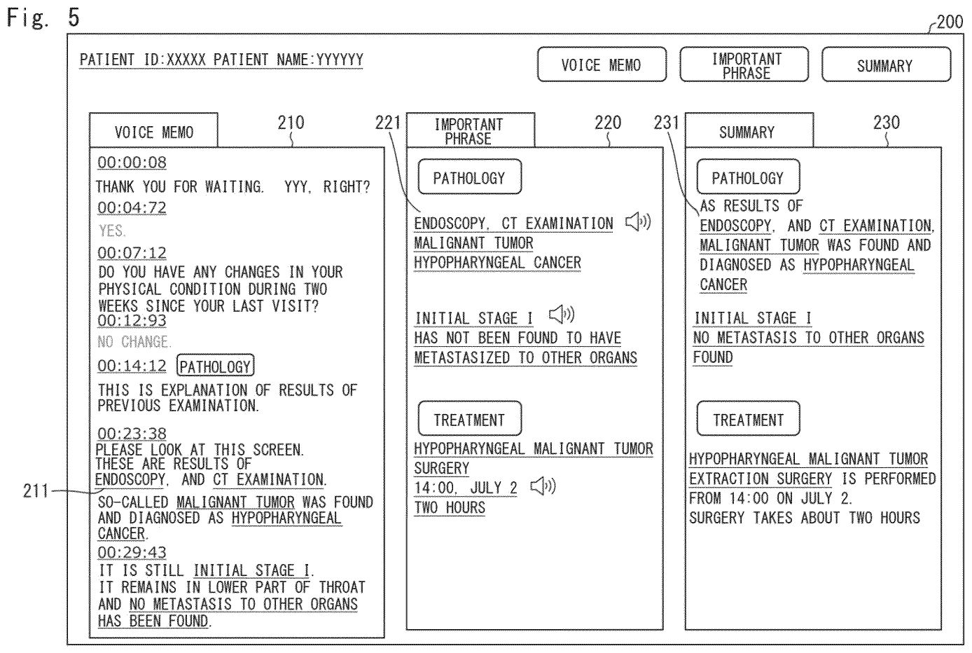

FIG. 5 is a schematic diagram illustrating another image 200 displayed in the display unit 70. The image 200 illustrates an example in which “voice memo”, “important phrase”, and “summary” are respectively displayed in display regions 210, 220, and 230. The “summary” is generated mainly about important phrases. All of the three items are not required to be displayed, and only the “voice memo” and the “summary” may be displayed.

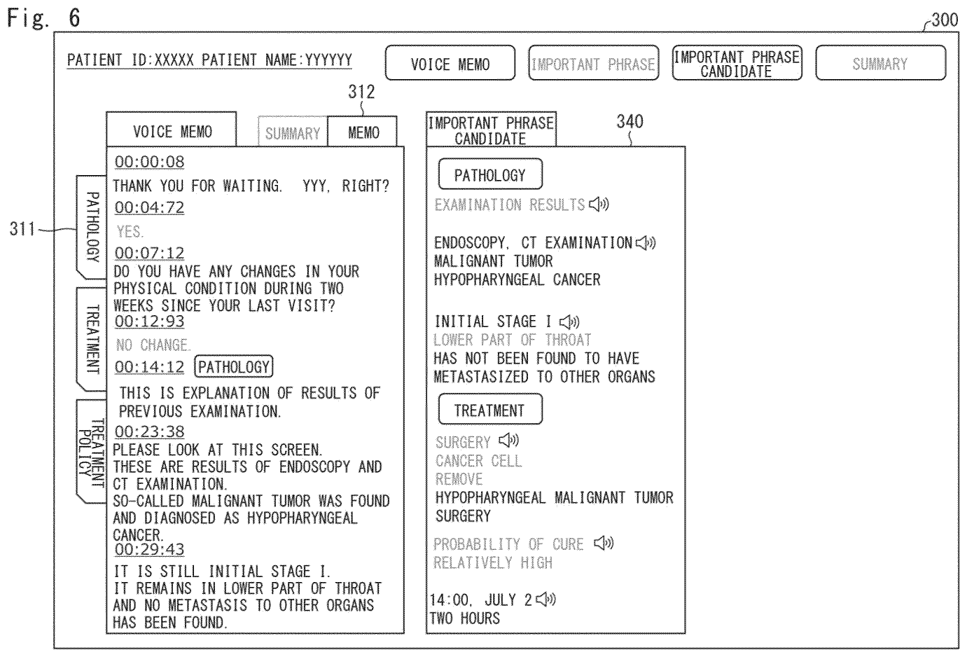

FIG. 6 is a schematic diagram illustrating another image 300 displayed in the display unit 70. The image 300 illustrates an example in which “important phrase candidate” is displayed in a display region 340. In this case, the summary generation unit 13 can generate important phrase candidates, and the display processing unit 14 can further display a fourth display region (display region 340) in which the important phrase candidates are displayed.

The “important phrase candidates” are at a stage where the “important phrase” is not yet defined, so that no underline is applied and another display region is not associated. The user can select a phrase considered to be important from among the important phrase candidates by clicking or the like. FIG. 6 expresses the phrase selected by the user from among the “important phrase candidates” using bold letters. The phrase selected by the user is recorded as the “important phrase”, and the phrase is associated with that in a different display region as described in FIG. 4.

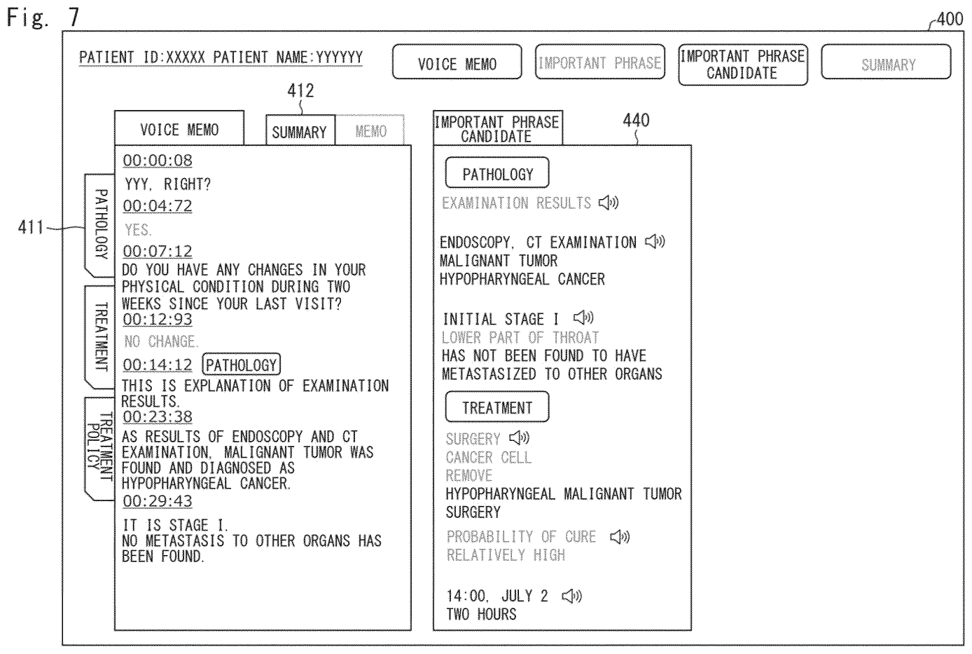

FIG. 6 shows the “voice memo” to which two tags of “summary” and “memo” are further added. The “summary” is a summary version of a voice memo. The “memo” is an entire version of the voice memo. As described above, the “voice memo” may be configured to allow the entire display and the summary display to be selected. FIG. 6 illustrates a screen on which the “memo” (entire version) of the “voice memo” is selected. Meanwhile, FIG. 7 illustrates a screen on which the “summary” (summary version) of the “voice memo” is selected. The “summary” of the voice memo may be obtained by organizing or summarizing sentences without breaking time-series display. For example, a redundant expression may be deleted in one speech section (or within one sentence), a sentence may be summarized or itemized, or spoken words may be converted into a sentence of written words.

### (Effect of Information Processing Apparatus 1A)

As described above, the information processing apparatus 1A uses a configuration in which the display processing unit displays at least two of the voice recognition text, the summary, and the important phrases by associating the at least two with each other. Thus, the information processing apparatus 1A obtains an effect in which at least two of the voice recognition text, the summary, and the important phrases can be displayed by comparing places of the same topic.

The information processing apparatus 1A also uses a configuration in which the summary generation unit further generates important phrase candidates, and the display processing unit further displays the fourth display region for displaying the important phrase candidates. Thus, the information processing apparatus 1A obtains an effect in which places each describing the same important phrase candidate can be displayed in comparison with each other.

The information processing apparatus 1A also uses a configuration in which the text acquisition unit 11 records the voice recognition text that can be distinguished for each utterer of voice, and the summary generation unit 13 switches the method for extracting the summary or the important phrase based on the utterer or the topic. Thus, the information processing apparatus 1A obtains an effect in which the summary or the important phrase can be extracted from speech contents of an expert, for example.

For one or more items related to a topic given by the user in advance, the information processing apparatus 1A uses a configuration in which the topic acquisition unit 12 assigns at least any one of the items to an acquired topic. Thus, the information processing apparatus 1A obtains an effect in which topics can be separated according to an item of a topic designated by the user.

The information processing apparatus 1A also uses a configuration in which the display processing unit 14 changes a display mode for each of displayed topics. Thus, the information processing apparatus 1A achieves an effect in which a range of topics can be easily recognized.

For a mouse operation (click or the like) performed on an important phrase or topic in one display region having been displayed, the information processing apparatus 1A uses a configuration in which the display processing unit 14 causes scrolling to a place of the important phrase or the topic in another display region having been displayed. Thus, the information processing apparatus 1A achieves an effect in which a common important phrase or contents of a common topic can be compared and referred to in a plurality of display regions on one display screen.

The information processing apparatus 1A also uses a configuration in which the display processing unit 14 further displays an item name of a topic for each display region. Thus, the information processing apparatus 1A achieves an effect in which contents of a topic can be understood at a glance.

Consequently, the information processing apparatus 1A achieves an effect in which an improved user interface can be provided for an electronic device.

### Third Exemplary Example Embodiment

A third exemplary example embodiment that is an example of an example embodiment of the present disclosure will be described in detail with reference to the drawings. Components having the same functions as the components described in the above-described exemplary example embodiment will be denoted by the same reference signs, and description of the components will be appropriately omitted. An application range of each technique used in the present exemplary example embodiment is not limited to the present exemplary example embodiment. That is, each technique used in the present exemplary example embodiment can also be used in another exemplary example embodiment included in the present disclosure within a range in which no particular technical problem occurs. Each technique illustrated in each of the drawings referred to for describing the present exemplary example embodiment can be employed in the other exemplary example embodiments included in the present disclosure within the scope in which no particular technical problem occurs.

### (Configuration of Information Processing Apparatus 1B)

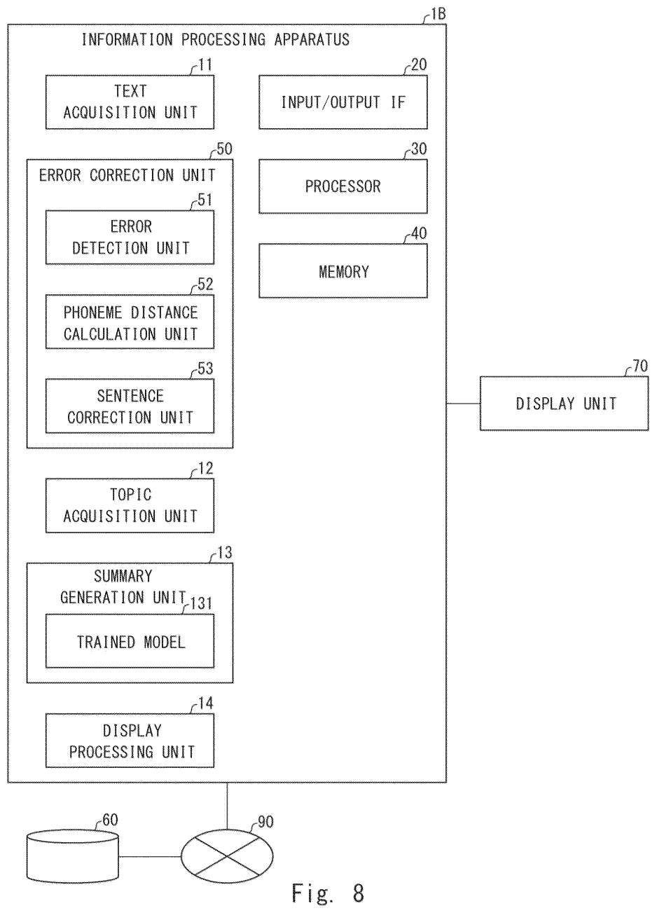

A configuration of an information processing apparatus 1B will be described with reference to FIG. 8. FIG. 8 is a block diagram illustrating the configuration of the information processing apparatus 1B. The information processing apparatus 1B includes not only the text acquisition unit 11, the topic acquisition unit 12, the summary generation unit 13, and the display processing unit 14 provided in the information processing apparatus 1, but also an error correction unit 50. The summary generation unit 13 includes a learned model 131.

The information processing apparatus 1B includes an input/output IF 20, at least one processor 30, and at least one memory 40. The information processing apparatus 1B may be connected to a display unit 70. Communication between the input/output IF 20 and the outside (e.g., a database 60) may be performed through the Internet 90, for example.

The error correction unit 50 corrects an error of voice recognition text acquired by the text acquisition unit 11. The error correction unit 50 includes an error detection unit 51, a phoneme distance calculation unit 52, and a sentence correction unit 53.

The error detection unit 51 inputs the voice recognition text and a prompt for detecting an error word of voice recognition from the voice recognition text into a first large language model, and acquires an error word output from the first large language model, for example.

The phoneme distance calculation unit 52 acquires one or more phoneme strings of reading the error word, and outputs word correction candidates in which a phoneme distance between two phonemes in the phoneme string is equal to or less than a predetermined threshold value.

The sentence correction unit 53 inputs the error word, the word correction candidates output for the error word, and a prompt for instructing to select a word correction candidate to be replaced with the error word into a second large language model, and outputs the voice recognition text in which the word correction candidates output from the second large language model are reflected in the voice recognition text.

### Implementation Example by Software

Some or all of the functions of the information processing apparatuses 1, 1A, and 1B (referred to below also as “each of the apparatuses above”) may be implemented by hardware such as an integrated circuit (IC chip) or may be implemented by software.

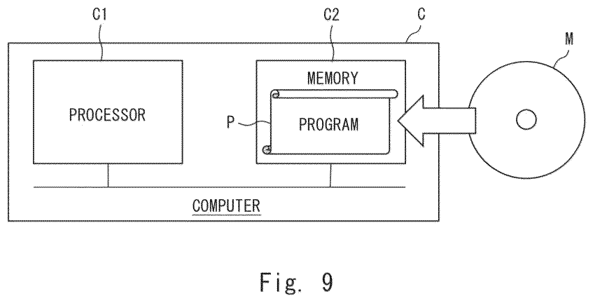

For the implementation by software, each of the apparatuses above is achieved by a computer that executes a command of a program as software for achieving each function, for example. FIG. 9 illustrates an example of a computer as described above (referred to below as a computer C). FIG. 9 is a block diagram illustrating a hardware configuration of the computer C functioning as each of the apparatuses above.

The computer C includes at least one processor C1 and at least one memory C2. A program P for causing the computer C to operate as each of the apparatuses above is recorded in the memory C2. The computer C implements each of functions of the respective information processing apparatuses above by allowing the processor C1 to read the program P from the memory C2 and execute the program P.

Available examples of the processor C1 include a central processing unit (CPU), a graphics processing unit (GPU), a digital signal processor (DSP), a micro processing unit (MPU), a floating point number processing unit (FPU), a physics processing unit (PPU), a tensor processing unit (TPU), a quantum processor, a microcontroller, and a combination thereof. Available examples of the memory C2 include a flash memory, a hard disk drive (HDD), a solid state drive (SSD), and a combination thereof.

The computer C may further include a random access memory (RAM) for loading the program P at the time of execution and temporarily storing various types of data. The computer C may further include a communication interface for sending and receiving data to and from another device. The computer C may further include an input/output interface for connecting input/output devices such as a keyboard, a mouse, a display, and a printer.

The program P can be recorded in a non-transitory tangible recording medium M readable by the computer C. Available examples of the recording medium M include a tape, a disk, a card, a semiconductor memory, and a programmable logic circuit.

The computer C can acquire the program P using the recording medium M described above. The program P can be transmitted through a transmission medium. Available examples of the transmission medium include a communication network, and a broadcast wave. The computer C can also acquire the program P through the transmission medium described above.

Each of the functions above of the respective apparatuses above may be implemented by a single processor provided in a single computer, may be implemented by cooperation of a plurality of processors provided in a single computer, or may be implemented by cooperation of a plurality of processors provided in each of a plurality of computers. The program for causing each of the apparatuses above to implement corresponding one of the functions above may be stored in a single memory provided in a single computer, may be stored in a plurality of memories provided in a single computer in a distributed manner, or may be stored in a plurality of memories provided in each of a plurality of computers in a distributed manner.

### Supplementary Matter 1

The present disclosure includes techniques described in each of Supplementary Notes below. However, the present disclosure is not limited to the techniques described in each of Supplementary Notes below, and various modifications can be made within the scope described in the claims.

### (Supplementary Note 1)

An information processing apparatus including:
a text acquisition unit configured to acquire voice recognition text obtained by converting voice into text;
a topic acquisition unit configured to acquire a topic included between boundaries by estimating the boundaries of a topic in the voice recognition text using a topic boundary estimation model for estimating boundaries of a topic in the text;
a summary generation unit configured to generate a summary of the topic and an important phrase for each range of the voice recognition text divided by the boundaries; and
a display processing unit configured to display at least two display regions among at least display regions respectively displaying the voice recognition text, the summary, and the important phrase in parallel on a display screen while the at least two display regions are each divided into ranges different in the topic.

### (Supplementary Note 2)

The information processing apparatus described in Supplementary Note 1, in which the display processing unit displays at least two of the voice recognition text, the summary, and the important phrases by associating the at least two with each other.

### (Supplementary Note 3)

The information processing apparatus described in Supplementary Note 1 or 2, in which the summary generation unit further generates important phrase candidates, and the display processing unit further displays a fourth display region for displaying the important phrase candidates.

### (Supplementary Note 4)

The information processing apparatus described in any one of Supplementary Notes 1 to 3, in which the text acquisition unit records the voice recognition text that can be distinguished for each utterer of the voice, and the summary generation unit switches a method for extracting the summary or the important phrase, based on the utterer or the topic.

### (Supplementary Note 5)

The information processing apparatus described in any one of Supplementary Notes 1 to 4, in which for one or more items related to the topic given by a user in advance, the topic acquisition unit assigns at least any one of the items to the topic acquired.

### (Supplementary Note 6)

The information processing apparatus described in any one of Supplementary Notes 1 to 5, in which the display processing unit changes a display mode for each of displayed topics including the topic.

### (Supplementary Note 7)

The information processing apparatus described in any one of Supplementary Notes 1 to 6, in which for a mouse operation (click or the like) performed on the important phrase or the topic in one of the display regions having been displayed, the display processing unit causes scrolling to a place of the important phrase or the topic in the other display region having been displayed.

### (Supplementary Note 8)

The information processing apparatus described in any one of Supplementary Notes 1 to 7, in which the display processing unit further displays an item name of the topic for each of the display regions.

### (Supplementary Note 9)

An information processing method including:
acquiring voice recognition text obtained by converting voice into text;
acquiring a topic included between boundaries by estimating the boundaries of a topic in the voice recognition text using a topic boundary estimation model for estimating boundaries of a topic in the text;
generating a summary of the topic and an important phrase for each range of the voice recognition text divided by the boundaries; and
displaying at least two display regions among at least display regions respectively displaying the voice recognition text, the summary, and the important phrase in parallel on a display screen while the at least two display regions are each divided into ranges different in the topic.

### (Supplementary Note 10)

An information processing program that causes a computer to perform the following:
text acquisition processing of acquiring voice recognition text obtained by converting voice into text;
topic acquisition processing of acquiring a topic included between boundaries by estimating the boundaries of a topic in the voice recognition text using a topic boundary estimation model for estimating boundaries of a topic in the text;
generation processing of generating a summary of the topic and an important phrase for each range of the voice recognition text divided by the boundaries; and
display processing of displaying at least two display regions among at least display regions respectively displaying the voice recognition text, the summary, and the important phrase in parallel on a display screen while the at least two display regions are each divided into ranges different in the topic.

### (Supplementary Note 11)

The information processing apparatus described in any one of Supplementary Notes 1to 8, further including:
an error detection unit that inputs the voice recognition text and a prompt for detecting an error word of voice recognition from the voice recognition text into a first large language model, and acquires the error word output from the first large language model;
a phoneme distance calculation unit that acquires one or more phoneme strings of reading of the error word and outputs a word correction candidate in which a phoneme distance between two phonemes in the phoneme string is equal to or less than a predetermined threshold value; and
a sentence correction unit that inputs the error word, the word correction candidates output for the error word, and a prompt for instructing to select a word correction candidate to be replaced with the error word into a second large language model, and outputs the voice recognition text in which the word correction candidates output from the second large language model are reflected in the voice recognition text.

### (Supplementary Note 12)

The information processing apparatus described in any one of Supplementary Notes 1to 9, in which the summary generation unit selects the important phrase from the summary using a trained model.

### Supplementary Matter 2

The present disclosure includes techniques described in each of Supplementary Notes below. However, the present disclosure is not limited to the techniques described in each of Supplementary Notes below, and various modifications can be made within the scope described in the claims.

### (Supplementary Note 21)

### An Information Processing Apparatus Including:

at least one processor,
the at least one processor being configured to perform the following:
   text acquisition processing of acquiring voice recognition text obtained by converting voice into text;
   topic acquisition processing of acquiring a topic included between boundaries by estimating the boundaries of a topic in the voice recognition text using a topic boundary estimation model for estimating boundaries of a topic in the text;
   summary generation processing of generating a summary of the topic and an important phrase for each range of the voice recognition text divided by the boundaries; and
   display processing of displaying at least two display regions among at least three display regions respectively displaying the voice recognition text, the summary, and the important phrase in parallel on a display screen while the at least two display regions are each divided into ranges different in the topic.

The information processing apparatus may further include a memory. The memory may store a program for causing the at least one processor to perform each type of the processing.

### (Supplementary Note 22)

The information processing apparatus described in Supplementary Note 21, in which the processor causes at least two of the voice recognition text, the summary, and the important phrases to be displayed by associating the at least two with each other in the display processing.

### (Supplementary Note 23)

The information processing apparatus described in Supplementary Note 21, in which the processor causes not only important phrase candidates to be further generated in the summary generation processing, but also a fourth display region for displaying the important phrase candidates to be further displayed in the display processing.

### (Supplementary Note 24)

The information processing apparatus described in Supplementary Note 21, in which the processor causes not only the voice recognition text to be recorded in a distinguishable manner for each utterer of the voice in the text acquisition processing, but also a method for extracting the summary or the important phrase to be switched based on the utterer or the topic in the summary generation processing.

### (Supplementary Note 25)

The information processing apparatus described in Supplementary Notes 21, in which for one or more items related to the topic given by a user in advance, the processor causes at least any one of the items to be assigned to the topic acquired, in the topic acquisition processing.

### (Supplementary Note 26)

The information processing apparatus described in Supplementary Note 21, in which the processor causes a display mode to be changed for each of displayed topics including the topic in the display processing.

### (Supplementary Note 27)

The information processing apparatus described in Supplementary Note 21, in which for a mouse operation (click or the like) performed on the important phrase or the topic in one of the display regions having been displayed, the processor causes scrolling to a place of the important phrase or the topic in the other display region having been displayed in the display processing.

### (Supplementary Note 28)

The information processing apparatus described in Supplementary Note 21, in which the processor causes an item name of the topic to be further displayed for each of the display regions in the display processing.

### Supplementary Matter 3

The present disclosure includes techniques described in each of Supplementary Notes below. However, the present disclosure is not limited to the techniques described in each of Supplementary Notes below, and various modifications can be made within the scope described in the claims.

### (Supplementary Note 31)

An information processing method that causes at least one processor to perform the following:
text acquisition processing of acquiring voice recognition text obtained by converting voice into text;
topic acquisition processing of acquiring a topic included between boundaries by estimating the boundaries of a topic in the voice recognition text using a topic boundary estimation model for estimating boundaries of a topic in the text;
summary generation processing of generating a summary of the topic and an important phrase for each range of the voice recognition text divided by the boundaries; and
display processing of displaying at least two display regions among at least three display regions respectively displaying the voice recognition text, the summary, and the important phrase in parallel on a display screen while the at least two display regions are each divided into ranges different in the topic.

### (Supplementary Note 32)

The information processing method described in Supplementary Note 31, in which the processor causes at least two of the voice recognition text, the summary, and the important phrases to be displayed by associating the at least two with each other in the display processing.

### (Supplementary Note 33)

The information processing method described in Supplementary Note 31 or 32, in which the processor causes not only important phrase candidates to be further generated in the summary generation processing, but also a fourth display region for displaying the important phrase candidates to be further displayed in the display processing.

### (Supplementary Note 34)

The information processing method described in any one of Supplementary Notes 31 to 33, in which the processor causes not only the voice recognition text to be recorded in a distinguishable manner for each utterer of the voice in the text acquisition processing, but also a method for extracting the summary or the important phrase to be switched based on the utterer or the topic in the summary generation processing.

### (Supplementary Note 35)

The information processing method described in any one of Supplementary Notes 31 to 34, in which for one or more items related to the topic given by a user in advance, the processor causes at least any one of the items to be assigned to the topic acquired, in the topic acquisition processing.

### (Supplementary Note 36)

The information processing method described in any one of Supplementary Notes 31 to 35, in which the processor causes a display mode to be changed for each of displayed topics including the topic in the display processing.

### (Supplementary Note 37)

The information processing method described in any one of Supplementary Notes 31 to 36, in which for a mouse operation (click or the like) performed on the important phrase or the topic in one of the display regions having been displayed, the processor causes scrolling to a place of the important phrase or the topic in the other display region having been displayed in the display processing.

### (Supplementary Note 38)

The information processing method described in any one of Supplementary Notes 31 to 37, in which the processor causes an item name of the topic to be further displayed for each of the display regions in the display processing.

1. An information processing apparatus comprising:
at least one computer-readable medium storing computer-executable instructions;
at least one processor communicatively coupled to the at least one computer-readable medium and configured to execute the computer executable instructions, the execution carrying out operations including:
acquiring voice recognition text obtained by converting voice into text;
acquiring a topic included between boundaries by estimating the boundaries of a topic in the voice recognition text using a topic boundary estimation model for estimating boundaries of a topic in the text;
generating a summary of the topic and an important phrase for each range of the voice recognition text divided by the boundaries; and
displaying at least two display regions among at least three display regions respectively displaying the voice recognition text, the summary, and the important phrase in parallel on a display screen while the at least two display regions are each divided into ranges different in the topic.

2. The information processing apparatus according to claim 1, wherein at least two of the voice recognition text, the summary, and the important phrases are displayed by associating the at least two with each other.

3. The information processing apparatus according to claim 1, wherein important phrase candidates are further generated, and a fourth display region is further displayed for displaying the important phrase candidates.

4. The information processing apparatus according to claim 1, wherein the voice recognition text that can be distinguished for each utterer of the voice is recorded, and a method for extracting the summary or the important phrase is switched, based on the utterer or the topic.

5. The information processing apparatus according to claim 1, wherein for one or more items related to the topic given by a user in advance, the topic acquisition unit assigns at least any one of the items to the topic acquired.

6. The information processing apparatus according to claim 1, wherein a display mode for each of displayed topics including the topic is changed.

7. The information processing apparatus according to claim 1, wherein for a mouse operation performed on the important phrase or the topic in one of the display regions having been displayed, scrolling is performed, to a place of the important phrase or the topic in the other display region having been displayed.

8. The information processing apparatus according to claim 1, wherein an item name of the topic for each of the display regions is further displayed.

9. The information processing apparatus according to claim 1, wherein the important phrase from the summary is selected using a model trained by using machine learning.

10. An information processing method comprising:
acquiring voice recognition text obtained by converting voice into text;
acquiring a topic included between boundaries by estimating the boundaries of a topic in the voice recognition text using a topic boundary estimation model for estimating boundaries of a topic in the text;
generating a summary of the topic and an important phrase for each range of the voice recognition text divided by the boundaries; and
displaying at least two display regions among at least three display regions respectively displaying the voice recognition text, the summary, and the important phrase in parallel on a display screen while the at least two display regions are each divided into ranges different in the topic.

11. The information processing method according to claim 10, wherein at least two of the voice recognition text, the summary, and the important phrases are displayed by associating the at least two with each other.

12. The information processing method according to claim 10, wherein important phrase candidates are further generated, and a fourth display region is further displayed for displaying the important phrase candidates.

13. The information processing method according to claim 10, wherein the voice recognition text that can be distinguished for each utterer of the voice is recorded, and a method for extracting the summary or the important phrase is switched, based on the utterer or the topic.

14. The information processing method according to claim 10, wherein the important phrase from the summary is selected using a model trained by using machine learning.

15. A non-transitory computer readable medium storing a program that causes a computer to execute information processing comprising:
acquiring voice recognition text obtained by converting voice into text;
acquiring a topic included between boundaries by estimating the boundaries of a topic in the voice recognition text using a topic boundary estimation model for estimating boundaries of a topic in the text;
generating a summary of the topic and an important phrase for each range of the voice recognition text divided by the boundaries; and
displaying at least two display regions among at least three display regions respectively displaying the voice recognition text, the summary, and the important phrase in parallel on a display screen while the at least two display regions are each divided into ranges different in the topic.

16. The non-transitory computer readable medium according to claim 15, wherein at least two of the voice recognition text, the summary, and the important phrases are displayed by associating the at least two with each other.

17. The non-transitory computer readable medium according to claim 15, wherein important phrase candidates are further generated, and a fourth display region is further displayed for displaying the important phrase candidates.

18. The non-transitory computer readable medium according to claim 15, wherein the voice recognition text that can be distinguished for each utterer of the voice is recorded, and a method for extracting the summary or the important phrase is switched, based on the utterer or the topic.

19. The non-transitory computer readable medium according to claim 15, wherein the important phrase from the summary is selected using a model trained by using machine learning.
